(19) United States
(12) Patent Application Publication
(10) Pub. No.: US 2021/0133840 A1
(43) Pub. Date: May 6, 2021

(54) Method for Clients and Contractors to Submit their Info Online To Estimate a Project

(71) Applicant: Michael Drew Cassidy, Decatur, GA (US)

(72) Inventor: Michael Drew Cassidy, Decatur, GA (US)

(21) Appl. No.: 16/672,435

(22) Filed: Nov. 2, 2019

(51) Int. Cl. G06Q 30/06; G06Q 10/06

(52) U.S. Cl. CPC G06Q 30/0611; G06Q 10/0637

(57) ABSTRACT

Systems and methods are disclosed herein for completely automated system for contractors to provide their bid on the project which is advertised on website. The system provides complete details of project including pictures, videos, measurements and other relevant information. The contractors can bid online and provide their cost and time frame without visiting the place physically. The customer can select the best offer based on their requirements.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

Embodiments relate to the field of housing-related activities, and particularly, to a method for contractors to be able to submit their estimate online and allow other contractors to have virtual tour to provide their estimations.

### Description of the Related Art

The US construction industry suffered a downturn in 2017, contracting by 1% in real terms that year, following an average annual growth of 5% during the preceding four years. This decline can be attributed to the slowdown in non-residential buildings construction activity and the decline in the government s outlay on major infrastructure projects.

The country's construction industry is expected to record positive growth over the forecast period (2018-2022), driven by the government's plans to revamp the country's depleted infrastructure. In addition, public and private sector investments in residential, commercial, healthcare and educational infrastructure construction projects are expected to support growth in the industry over the forecast period.

There are multiple inventions that have been proposed in prior art regarding advancements in construction industry. For instance, Housing space-related commodity sale assisting system, housing space-related commodity sale assisting method, program for assisting housing space-related commodity sale, and computer-readable recorded medium on which program for assisting housing space-related commodity sale is recorded bearing U.S. Pat. No. 7,080,096B1 is issued to Panasonic Corp. The system discloses an inventive system includes a database for storing housing display data including layout information of a housing such as a real estate object, an interior display data including information regarding interior of the housing, and furniture display data including configuration information regarding furniture to be arranged in the housing. The inner space of the housing is displayable as a virtual space on the terminal of a computer of a prospective purchaser based on each of the data. The system provides a browser equipped with a manipulating menu with which a user manipulates the viewpoint or location of viewing in the virtual space. The system provides the user with each of the data via the Internet or its equivalent.

Another patent on Modular prefabricated house bearing U.S. Pat. No. 8,733,029B2 is issued to 500 Group Inc. The patent is on a prefabricated house including two or more modules including a core module having a fixed space portion and a passive space portion. The fixed space portion includes non-foldable walls. The fixed space portion has a functionality beyond providing volume. The passive space portion has one or more foldable panels. Each foldable panel is movable from a first, closed position to second open position.

Another patent on System and method of panelized construction bearing U.S. Pat. No. 6,854,218B2 is issued to Fairfax Express Corp. The patent is on a system and method of panelized construction for use in construction of a building module, such as a residential housing addition. A plurality of pre-fabricated panels, such as wall panels, roof panels, floor panels, and ceiling panels may be provided to decrease on-site building time. The panels may comprise one or more covering layers pre-installed on a frame. The panels may also comprise pre-installed insulation or other core materials. The panels may further comprise a pre-installed portion of a house system, such as an electrical system. Additionally, the panels may comprise pre-installed windows, doors, or skylights. The panels may be designed to meet the residential building code requirements of one or more jurisdictions to decrease permitting time and inspection delays. The panels and other materials may be included in a building kit for a building module to be constructed by contractors or do-it-yourselfers.

A Real estate search and location system and method bearing U.S. Pat. No. 5,032,989A is issued to REAL ESTATE ALLIANCE Ltd REALPRO Ltd A CORP OF. The patent aims on providing a method for locating available real estate properties for sale, lease or rental using a database of available properties at a central location and remote stations which use a graphic interface to select desired regions on a map of the areas in interest. The user begins with a region where they are interested in acquiring property and select an inner area within this region by using a pointing device such as a mouse to designate boundaries on a map displayed on screen. This is then zoomed in on and a second area is selected within the zoomed region. The second area is then cross-referenced with the database of available properties whose approximate locations are then pictorially displayed on screen. Information about the properties can then be obtained in textual form.

Another invention on Real-estate method and apparatus for searching for homes in a search pool for exact and close matches according to primary and non-primary selection criteria bearing U.S. Pat. No. 5,754,850A is issued to RealSelect Inc. The patent is on a method and apparatus which is provided for a search system based in software running on a personal computer. The personal computer is housed in a kiosk having a touch monitor and a printer. With the search system, selection features are selected and a search based upon these search features is performed. Each item in a database is examined to determine if an item has a given search feature. These search features are categorized into primary and non-primary search features. Items neither satisfying nor closely satisfying a given primary search feature are eliminated from the search. In contrast, items not satisfying a given non-primary feature may remain in a search pool. For both primary and non-primary features, if an item in a database is an exact match to a given search feature, then that item is assigned full points. If an item closely satisfies the search feature, then that item is assigned full or partial points. After completion of comparing each primary and non-primary search feature with each item in the search pool, predetermined number of items remaining in the search pool with the highest total points are displayed to the user of the search system.

A System for facilitating home construction and sales bearing U.S. Pat. No. 5,991,769A is issued to HALL DATA SYNC TECHNOLOGIES LLC. The patent is on a system for facilitating the information transfer and processing associated with home construction and home sales. Various discrete software modules are disclosed each handling a specific task associated with home construction and sales. Also, a system for communicating between separate data bases is disclosed wherein separate and distinct sales offices, each having their own data base, may communicate with a parent, market office having its own data base wherein the data bases of the sales offices and the market office are synchronized according to the method of the present invention so that any data updates in any of the sales offices would be automatically updated in the associated market offices. This aspect of the present invention allows a corporation responsible for home construction and sales amongst various regional, market, and sales offices to coordinate a plurality of discretely separate data bases in a way such that they are all synchronized with one another at a predetermined time.

A System for providing automated real estate services bearing US patent 2,001,0034607A1 is issued to GREENRIDGE REALTY Inc. The patent is on a real estate service system for providing real estate services in a retail shopping mall includes a server for storing and providing automated access to real estate service information and a real estate kiosk that includes a computer system that is coupled to the server. The real estate kiosk is located in a retail shopping mall and provides automated real estate service information to a potential buyer based on the potential buyer's indicated preference. The computer system includes a processing unit, a storage unit, an output unit and an input unit. The storage unit is coupled to the processing unit and stores real estate service information. The output unit is coupled to the processing unit and provides real estate service information that corresponds to the potential buyer's indicated preference. The input unit is also coupled to the processing unit and receives the potential buyer's indicated preference.

A Real estate value map computer system bearing U.S. Pat. No. 6,323,885B1 is issued to F POSZAT HU LLC. The patent is on a computer system creates and displays a map image based upon a value database associating a plurality of values each with a geographic location in a geographic area and a map program associating each location with a map image location. The computer system assigns one of a plurality of symbols to each geographic location based upon its associated value. The symbol is then displayed on the map image at the map image location associated with the geographic location.

There are multiple inventions that have been proposed in prior art regarding advancement in construction system. However, the utility of these systems has not been seen in advance form and for specialized needs. Usually in a normal case, currently in the United States consumers who want a bid to do work on their home, whether that be painting, carpentry, flooring Etc. will contact a contractor either by use of the internet or sites like nextdoor.com. Where typical contractors would do their advertising. An average consumer will get more than one estimate. This figure is normally between three to five estimates for any given project. However, this proves to be wasteful and is very time-consuming for the client or the customer because they have to go meet with the contractor and show them the same measurements and the same images and the same project every time.

The current invention proposes a system which provides a method for contractors to be able to submit their estimate online without visiting a client's house. This method includes, a client to take photographs and measurements similar to real estate sites, where you can do a virtual tour. The contractor that is either going to do painting, carpentry, roofing or any other similar type of service would only need to be able to look online at photos and measurements. And then just do their bid online. The client would be able to review multiply contractor video submitted bids online. In viewing these video bids, they would be able to choose one contractor without the need for multiply contractors having to come to the residence just to give an identical purposed bid on painting, carpentry or any other type of similar work. Video conferencing between the chosen contractor and the client could then be the next step in this process. The process is completely automated and involves the pictures and videos of job site only

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a system and method for automated handling of construction work at residential sites.

It is also the objective of the invention to provide a system which is totally automated and allows consumers to post images and videos of the project, so that contractors can view them online.

It is further the objective of the invention to provide a system which provides an automated way of handling construction related jobs for contractors and allow them to view and provide estimations on job site without the requirement of physical visit.

It is also the objective of the invention to provide a system which has as its main object the provision is to save time and cost for both of the parties involved and allow the home owners and contractors to get mutually benefited through this automated system.

It is moreover the objective of the invention to provide a system which can be used easily and provides consistent services for contractors and home owners.

It is moreover the objective of the invention to provide a system which is of a durable and reliable construction.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 displays a flowchart depicting a method for clients and contractors to submit information online to estimate a project in accordance with embodiments.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

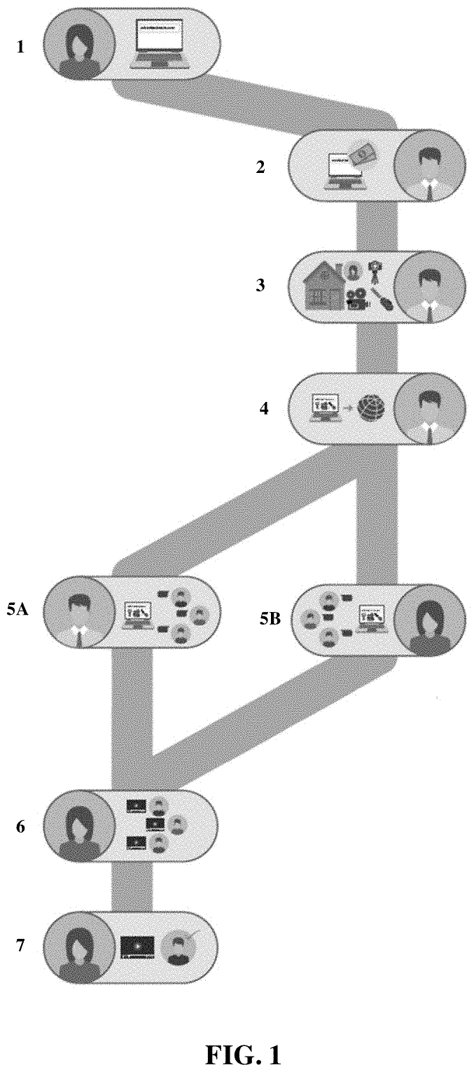

The current invention in its preferred embodiment discloses a method for contractors to submit their estimates online with regards to construction related work, as shown in FIG. 1.

The system typically works in following way including the website (such as, but not limited to, www.submitestimate.com) where client would contact for services (Step 1). On the payment of charges for services to be rendered (Step 2), an independent team will arrive at clients home to take videos, photographs, and measurements of the following estimates that the client would like to complete (Step 3). In embodiments, the services may include any type of home contracting work (exterior, interior, etc.).

The system as per its additional embodiments includes that after acquiring various measurements, photographs, and videos, future projects to be estimated on, these items would then be loaded onto the computer and then onto the internet to the independent company's website (such as, but not limited to, www.submitestimate.com and www.youtube.com) or server for review and editing, as shown in Step 4. In embodiments, the various measurements, photographs, and videos, future projects to be estimated on may be held in another secure environment.

This service/business would then communicate with prospective contractors, allowing them to view the measurements, photographs and videos of the job to be performed, as shown in Step 5A. This service will also allow a client to choose/send contractors to this website/server, to bid on their project, as shown in Step 5B.

The system allows various contractors to be contacted by any means. It further allows the contractors to go online to the website and view the photographs, videos, measurements and specs related to the job. In embodiments, online advertising of any establishment may be included on the website.

The contractor, after viewing items for the estimate that included the photos, videos and measurements of the project would then leave a video estimate for the client to view (Step 6). The client would not necessarily need to chat with the contractor initially, but just view their bio (or back ground check) and their video response to giving the estimate.

The Client selects contractor for their particular project (Step 7). A meeting or conversation with said contractor is then set up by phone, internet web chat (live video conferencing), or in person to confirm the project.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: A system for contractors to provide their bid comprising:
(a) an application to display on the user's output screen,
(b) providing an end user interface on the user's device,
(c) providing said website or application for running on mobile devices, laptops or desktop screen,
(d) a user terminal,
(e) means for collecting information especially via enabled location services from said end user by a display of one or more screens of selectable information at the beginning of execution of the application,
(f) a second display screen separated from the first display screen;
(g) a memory storing a customer database program;
(h) a processor whereby said processor will collect information directly from said end user;
(i) at least one processor in communication with the first and second display screens;
(j) accessing a project database including project videos, images, specs and other details;
(k) allowing contractors to propose their bid and timeline to complete the job, and
(l) generating information on at least one display screen relating to project and the bidder's details with their cost and project timelines estimates.
